(19) United States
(12) Patent Application Publication
(10) Pub. No.: US 2025/0343453 A1
(43) Pub. Date: Nov. 6, 2025

(54) ROTOR OF AN ELECTRIC MACHINE DESIGNED AS A PERMANENTLY EXCITED SYNCHRONOUS MACHINE, ELECTRIC MACHINE, AND MOTOR VEHICLE

(71) Applicant: Dr. Ing. h.c. F. Porsche Aktiengesellschaft, Stuttgart (DE)

(72) Inventors: David BAUER, Asperg (DE); Johannes WENDE, Heilbronn (DE); Christian KÖNEN, Stuttgart (DE); Niklas LAMPARSKY, Leonberg (DE); Sebastian GÖTZE, Vienna (AT)

(21) Appl. No.: 19/194,042

(22) Filed: Apr. 30, 2025

(30) Foreign Application Priority Data
May 3, 2024 (DE) 10 2024 112 536.5

(51) Int. Cl. H02K 1/276

(52) U.S. Cl. CPC H02K 1/276; H02K 2213/03

(57) ABSTRACT

A rotor including a rotor base body having radially outwardly open pocket-like recesses and permanent magnets positioned in the recesses, and poles which, viewed in a circumferential direction, are arranged alternately next to one another and form pole pairs. At least one permanent magnet group including the permanent magnets arranged in the recesses is positioned in a V-shape formed in a region of each pole, the permanent magnets diverging radially outwards. Radially outward ends of the permanent magnets positioned in the V-shape, which extend adjacent an outer circumference of the rotor base body, have an outer surface with a chamfer, which extends at a respective circumferential position of a respective radially outer end in a tangential direction or parallel to the tangential direction of the outer circumference of the rotor base body. The rotor base body supports a drum on the outer circumference.

### CROSS REFERENCE TO RELATED APPLICATIONS

This application claims benefit to German Patent Application No. DE 10 2024 112 536.5, filed on May 3, 2024, which is hereby incorporated by reference herein.

### FIELD

The present disclosure relates to a rotor of an electric machine, to an electric machine, and to a motor vehicle.

### BACKGROUND

The basic design of an electric machine is known from practice. Thus, an electric machine has a housing and a stator. The stator is also referred to as the stand. Furthermore, an electric machine has a rotor. The rotor is also referred to as the runner. The rotor is rotatably mounted in the housing.

EP 1 990 895 A2 discloses an electric machine comprising a rotor and a stator. The rotor comprises a rotor base body with pocket-like recesses in which permanent magnets are positioned. Radially outwardly closed and radially outwardly open pocket-like recesses are disclosed. In the area of each pole of the rotor, a permanent magnet group is formed from permanent magnets arranged in recesses.

DE 10 2018 219 244 A1 discloses a further rotor of an electric machine. A rotor base body of the rotor has radially outwardly closed recesses in which permanent magnets are arranged.

DE 199 41 107 A1 discloses a further rotor of an electric machine. The rotor has recesses arranged in a V-shape with respect to one another, which are radially outwardly closed and serve to receive permanent magnets.

U.S. Pat. No. 6,891,297 B2 discloses a further rotor of an electric machine which has recesses arranged in a V-shape in relation to one another for receiving permanent magnets.

U.S. Pat. No. 10,784,732 B2, DE 10 2022 111 494 A1, DE 10 2022 203 126 A1, and US 2023/0 179 045 A1 disclose further prior art.

### SUMMARY

In an embodiment, the present disclosure provides a rotor of an electrical machine configured as a permanently excited synchronous machine, the rotor comprising a rotor base body having radially outwardly open pocket-like recesses and permanent magnets positioned in the recesses, and poles which, viewed in a circumferential direction, are arranged alternately next to one another and form pole pairs. At least one permanent magnet group including the permanent magnets arranged in the recesses is positioned in a V-shape formed in a region of each pole, the permanent magnets of the at least one permanent magnet group diverging radially outwards. Radially outward ends of the permanent magnets arranged in the recesses positioned in the V-shape, which extend adjacent an outer circumference of the rotor base body, have an outer surface with a chamfer, which extends at a respective circumferential position of a respective radially outer end of a respective permanent magnet of the permanent magnets in a tangential direction or parallel to the tangential direction of the outer circumference of the rotor base body. The rotor base body supports a drum on the outer circumference.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a schematic section of an electric machine designed as a permanently excited synchronous machine, which serves as a drive unit in a motor vehicle;

FIG. 2 illustrates a schematic section of an electric machine designed as a permanently excited synchronous machine, which serves as a drive unit in a motor vehicle; and

FIG. 3 illustrates a motor vehicle having an electric machine serving as a drive unit.

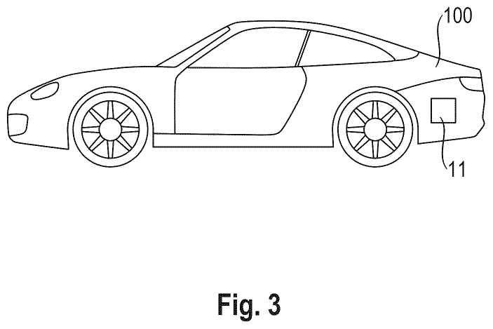

### DETAILED DESCRIPTION

Electrical machines used as drive units in motor vehicles, in particular in high-performance vehicles such as sports cars or race cars, require increasing amounts of power, increasing amounts of torque, and increasing maximum speeds. Until now, it has been difficult to provide a rotor of a permanently excited synchronous machine that can provide a high maximum speed and thus a high maximum circumferential speed or surface speed in the order of magnitude of more than 150 m/s in particular at high power and high torque. The present inventors have recognized that there is a need for a rotor of an electric machine designed as a permanently excited synchronous machine with which increased power and increased torque can be provided at a high maximum speed and thus a high maximum circumferential speed or surface speed.

In an embodiment, the present disclosure provides a rotor of an electrical machine designed as a permanently excited synchronous machine, which has a high torque density and high speed stability and also requires little installation space. Further, an electric machine having such a rotor and a motor vehicle having an electric machine comprising such a rotor are provided.

A rotor according to an aspect of the present disclosure comprises a rotor base body with radially outwardly open pocket-like recesses and permanent magnets positioned in the recesses, wherein the rotor has poles, which, viewed in the circumferential direction, are arranged alternately next to one another and form pole pairs, and wherein in the region of each pole at least one permanent magnet group is formed from permanent magnets arranged in recesses positioned in a V-shape, which diverge radially outwards.

In a rotor according to an aspect of the present disclosure, radially outward ends of the permanent magnets arranged in the recesses positioned in a V-shape, which extend adjacent an outer circumference of the rotor base body, have an outer surface with a chamfer, which extends at the respective circumferential position of the respective radially outward end of the respective permanent magnet in the tangential direction or parallel to the tangential direction of the outer circumference of the rotor base body. The rotor base body of the rotor according to an aspect of the present disclosure supports a drum on the outer circumference.

Because the permanent magnets positioned in the radially outwardly open recesses positioned in a V-shape have an outer surface with a chamfer adjacent to the outer circumference of the rotor base body, which extend in the tangential direction or parallel to the tangential direction of the outer circumference of the rotor base body at the respective circumferential position of the respective radially outer end of the respective permanent magnet, the magnetic mass per pole can be increased, so as to increase the power and torque of the electric machine. In combination with the drum on the outer circumference of the rotor base body, the maximum speed and thus the maximum circumferential speed or surface speed can also be increased.

Preferably, radially inward ends of the permanent magnets arranged in the recesses positioned in a V-shape, which run adjacent to a d-axis of the respective pole of the rotor, have an outer surface with a chamfer that extends in the direction of the pole d-axis or parallel to the d-axis of the respective pole. Again, the magnetic mass per pole and the power and torque available from the electric machine can be increased. Furthermore, an angle between the recesses positioned in a V-shape and thus between the permanent magnets positioned therein can be increased, which can also increase the power of the electric machine. A further advantage is that the mass to be supported is reduced and therefore there are reduced requirements for the drum.

If the rotor has permanent magnets with inhomogeneous material properties, the chamfers of the permanent magnets can be used to exclude incorrect construction of the permanent magnets during manufacturing. Accordingly, the chamfers of the permanent magnets can also be used as poka-yoke features in the manufacture of the rotor of an electric machine designed as a permanently excited synchronous machine.

Embodiments of the present disclosure will emerge from the following description. Design examples of the present disclosure will be explained in more detail with reference to the drawings, without being restricted thereto.

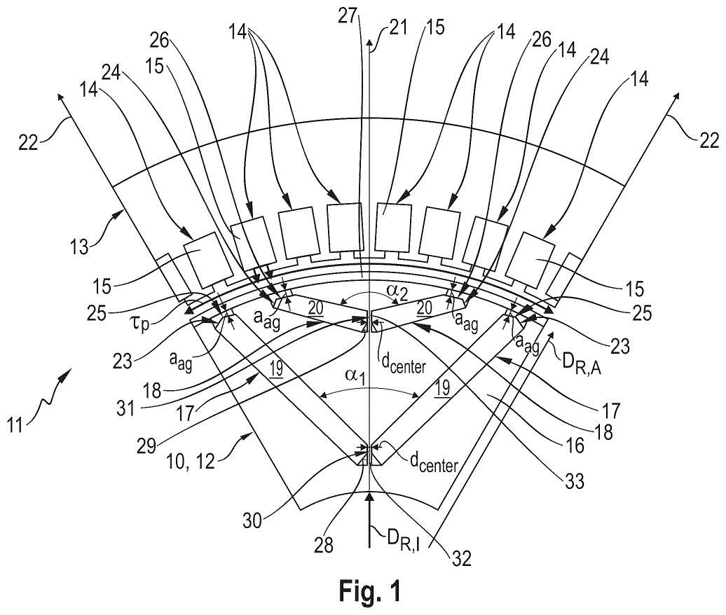

FIG. 1 shows a section of a rotor 10 of an electric machine 11 designed as a permanently excited synchronous machine. The electric machine 11 is preferably designed as a drive unit of a motor vehicle 100, namely a passenger vehicle designed as a hybrid vehicle or electric vehicle.

A stator 13 of the electric machine 11 adjoins the rotor 10 radially outwards. The rotor 10 and the stator 13 are accommodated in a housing of the electrical machine 11, the rotor 10 being rotatably mounted in the housing of the electrical machine 11.

FIG. 1 shows a section of the rotor 10 of the electric machine 11 in the region of a pole 12 of the rotor 10, wherein a plurality of poles 12 are arranged adjacent to one another as viewed in the circumferential direction and form pole pairs. Two poles each form a pair of poles. The circumferential extension τp of a pole 12 is 360°/2p. p corresponds to the number of pole pairs of the rotor 10.

The stator 13 has grooves 14 in which stator windings 15 are arranged. The stator windings 15 preferably form three chamfers.

The rotor 10 of the electric machine 11 has a rotor base body 16 with pocket-like recesses 17, 18 as well as with permanent magnets 19, 20 positioned in the pocket-like recesses 17, 18. In the exemplary embodiment shown in FIG. 1, there are radially inward recesses 17 and radially outward recesses 18, which are each radially outwardly open, aligned in a V-shape to one another and accommodate the permanent magnets 19, 20.

At least one permanent magnet group is formed from permanent magnets 19, 20 arranged in recesses 17, 18 positioned in a V-shape in the region of each pole 12 of the rotor 10 and thus of the electric machine 11, which diverge radially outwards. In this way, in the exemplary embodiment shown, the permanent magnets 19 arranged in the recesses 17 form a first radially inward permanent magnet group and the permanent magnets 20 arranged in the radially outward recesses 18 form a second radially outward permanent magnet group of the respective pole 12.

As already stated, FIG. 1 shows a section from a pole 12 of the rotor 10 of the electric machine 11. FIG. 1 shows a d-axis 21 of the pole 12 on the one hand and q-axis 22 of the same on the other hand.

The d-axis 21 of a respective pole 12 of the rotor 10 of the electric machine 11 extends in the radial direction in the center of the circumferential extension thereof.

The q-axes 22 of the pole 12 of the rotor 10 of the electric machine 11 also extend in the radial direction at the lateral circumferential limits of the respective pole 12.

As already stated, permanent magnets 19, 20 are arranged in the radially outwardly open pocket-like recesses 17, 18 positioned in a V-shape. Radially outward ends of the permanent magnets 19, 20 arranged in the recesses 17, 18, which extend adjacent an outer circumference of the rotor base body 16, have an outer surface 23, 24 with a chamfer 25, 26, which extends at the respective circumferential position of the respective radially outer end of the respective permanent magnet 19, 20 in the tangential direction or parallel to the tangential direction of the outer circumference of the rotor base body 16.

In the exemplary embodiment shown, the respective chamfer 25, 26 at the radially outward end of the respective permanent magnet 19, 20 extends parallel to the tangential direction of the outer circumference of the rotor base body and is offset radially inwardly with respect thereto, in such a way that the respective chamfer 25, 26 extends at a distance a_{ag} from the outer circumference of the rotor base body, which is in particular between 0.1 mm and 6 mm, preferably between 0.2 mm and 5 mm, particularly preferably between 0.5 mm and 3.5 mm.

In contrast, the chamfer 25, 26 at the radially outward end of the respective permanent magnet 19, 20 can extend tangentially to the outer circumference of the rotor at the respective circumferential position, wherein the distance a_{ag} is 0 mm.

The rotor base body 16 supports a drum 27 on the outer circumference.

Due to the design of permanent magnets 19, 20 according to the present disclosure, at their radially outward ends adjacent to the outer circumference of the rotor base body 16, namely by the chamfer 25, 26 extending tangentially or parallel to the tangential direction at the radially outward end of the respective permanent magnet 19, 20, the magnetic mass per pole 12 can be increased, whereby the performance and thus the torque can ultimately be increased.

According to FIG. 1, the rotor base body 16 preferably overlaps the chamfer 25, 26 of the respective permanent magnet 19, 20 at the radially outward end thereof in the circumferential direction, thereby holding the respective permanent magnet 19, 20 in position. The drum 27 also holds the rotor 10 together, thereby providing high maximum speeds and thus high maximum circumferential speeds or surface velocities for the rotor 10 with increased magnetic mass and therefore increased power and torque.

Preferably, radially inward ends of the permanent magnets 19, 20 arranged in the recesses 17, 18 positioned in a V-shape, which extend adjacent to the d-axis 21 of the respective pole 12, have an outer surface 28, 29 with a chamfer 30, 31 that extends in the direction of the d-axis 21 or parallel to the d-axis 21 of the respective pole 12. Then, when the chamfers 30, 31 extend in the direction of the d-axis 21, the chamfers 30 of the permanent magnets 19 and the chamfers 31 of the permanent magnets 20 abut, the distance d_{center} shown in FIG. 1 is then 0 mm. In FIG. 1, the chamfers 30 of the permanent magnets 19 and the chamfers 31 of the permanent magnets 20 do not abut one another, but are rather spaced apart from one another by a web 32 or 33 in the area of the d-axis 21, wherein the circumferential thickness of the respective web 32, 33 determines the distance d_{center} between the chamfers 30 of the permanent magnets 19 and the chamfers 31 of the permanent magnets 20. This distance d_{center} is in particular a maximum of 10 mm, preferably a maximum of 5 mm, particularly preferably a maximum of 3 mm.

The chamfers 30, 31 at the radially inward ends of the permanent magnets 19, 20 can also increase the magnetic mass per pole 12 in order to provide a higher power and a higher torque. Furthermore, the chamfers 30, 31 at the radially inward end of the permanent magnets 19, 20 allow larger angles α between the permanent magnets 19, 20 diverging radially outwards or between the recesses 17, 18 positioned in a V-shape. This is also advantageous for increasing the power and thus the torque.

In the exemplary embodiment shown in FIG. 1, two recesses 17, 18 are positioned in a V-shape per pole 12, namely, on the one hand, the radially inward recesses 17, and on the other hand, the radially outward recesses 18, in which permanent magnets 19, 20 are arranged, which form permanent magnet groups, namely, the permanent magnets 19 form an inner permanent magnet group and permanent magnets 20 form an outer permanent magnet group. In contrast to the exemplary embodiment shown, in an embodiment only one permanent magnet group is formed in the area of each pole 12, i.e., only two recesses positioned in a V-shape relative to one another are present.

Then, if a single permanent magnet group is formed per pole 12 or if, as shown in FIG. 1, two permanent magnet groups are formed per pole 12, the permanent magnets diverging radially outwards, namely, in the case of several permanent magnet groups, the permanent magnets of the inner permanent magnet group, or the recesses receiving the permanent magnets, include a first angle α1 between in particular 70° and 140°, preferably between 80° and 135°, particularly preferably between 45° and 130°. In FIG. 1, the radially outwardly diverging permanent magnets of the outer permanent magnet group or the recesses 18 receiving said permanent magnets include a second α2 which is in particular between 80° and 175°, preferably between 90° and 175°, particularly preferably between 100° and 175°, wherein in FIG. 1 the second angle α2 is greater than the first angle α1.

Preferably, the rotor 10 of the electric machine 11 comprises between two and five pole pairs. An outer diameter D_{R,A} of the rotor base body 16 is in particular between 90 mm and 170 mm, preferably between 110 mm and 170 mm, particularly preferably between 120 mm and 170 mm. An inner diameter D_{R,I} of the rotor base body 16 is in particular between 10 mm and 110 mm, preferably between 30 mm and 80 mm, particularly preferably between 40 mm and 80 mm.

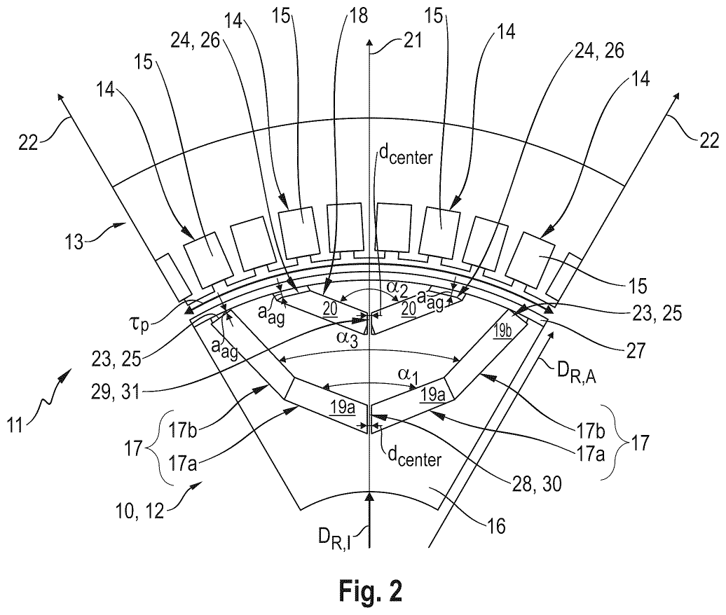

FIG. 2 shows a modification of the electric machine according to the present disclosure, in which the shaped radially inward recesses 17 arranged in a V-shape relative to one another are subdivided into two segments 17a, 17b, namely inner segments 17a and outer segments 17b, wherein the inner segments 17a or the magnets 19a accommodated by the inner segments 17a enclose the angle α1 and the outer segments 17b or the permanent magnets 19b accommodated by the same enclose a third angle α3. The first angle α3 is smaller than the first angle α1. The first angle α1 and the third angle α3 move in the angular ranges indicated in the embodiment of FIG. 1 for the angle α1.

With regard to all other details, the exemplary embodiment of FIG. 2 matches the exemplary embodiment of FIG. 1, such that to avoid unnecessary repetitions for the exemplary embodiment of FIG. 2, reference is made to the exemplary embodiment of FIG. 1 and like reference numerals are used for the same assemblies.

The present disclosure provides a rotor of an electric machine by means of which the electric machine can provide a high power and thus a high torque at a high maximum speed and thus at high maximum circumferential speed or surface speed. The electric machine is designed as a drive unit of a motor vehicle, namely a hybrid vehicle or electric vehicle.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A rotor of an electrical machine configured as a permanently excited synchronous machine, the rotor comprising:
a rotor base body having radially outwardly open pocket-like recesses and permanent magnets positioned in the recesses;
poles which, viewed in a circumferential direction, are arranged alternately next to one another and form pole pairs;
wherein at least one permanent magnet group including the permanent magnets arranged in the recesses is positioned in a V-shape formed in a region of each pole, the permanent magnets of the at least one permanent magnet group diverging radially outwards,
wherein radially outward ends of the permanent magnets arranged in the recesses positioned in the V-shape, which extend adjacent an outer circumference of the rotor base body, have an outer surface with a chamfer, which extends at a respective circumferential position of a respective radially outer end of a respective permanent magnet of the permanent magnets in a tangential direction or parallel to the tangential direction of the outer circumference of the rotor base body, and
wherein the rotor base body supports a drum on the outer circumference.

2. The rotor according to claim 1, wherein the chamfer at the radially outer end of the respective permanent magnet is offset radially inwards and extends at a distance of 0.1 mm to 6 mm from the outer circumference of the rotor base body parallel to the tangential direction.

3. The rotor according to claim 1, wherein the chamfer extends tangentially to the outer circumference of the rotor base body at the radially outer ends of the respective permanent magnet.

4. The rotor according to claim 1, wherein radially inner ends of the permanent magnets arranged in the recesses positioned in a V-shape extend adjacent to a d-axis of a respective pole of the rotor and have an outer surface with a chamfer that extends in a direction of the d-axis or parallel to the d-axis of the respective pole.

5. The rotor according to claim 4, wherein the radially inner ends of the permanent magnets arranged in the recesses contact the permanent magnet group of the respective pole.

6. The rotor according to claim 4, wherein the radial inner ends of the permanent magnets arranged in the recesses of the permanent magnet group have a distance between them of a maximum of 10 mm.

7. The rotor according to claim 1, wherein in an area of each pole, at least two permanent magnet groups are formed from the permanent magnets arranged in the recesses, the permanent magnets of each permanent magnet group being positioned in a respective V-shape.

8. The rotor according to claim 1, wherein at the permanent magnet group or groups of the respective pole, the radially outward diverging permanent magnets of the respective permanent magnet group enclose a first angle between 70° and 140°.

9. The rotor according to claim 8, wherein at an outer permanent magnet group of the respective pole, the radially outward diverging permanent magnets of the respective permanent magnet groups enclose a second angle between 80° and 175°.

10. The rotor according to claim 1, wherein an outer diameter of the rotor base body is between 90 mm and 170 mm, and wherein an inner diameter of the rotor base body is between 10 mm and 110 mm.

11. The rotor according to claim 1, wherein the rotor has between two and five pole pairs.

12. An electric machine with the rotor according to claim 1, wherein the electric machine is configured as a drive unit of a hybrid vehicle or electric vehicle.

13. A motor vehicle with an electric machine configured as a drive unit, the motor vehicle comprising the rotor according to claim 1, wherein the motor vehicle is a hybrid vehicle or an electric vehicle.

14. The rotor according to claim 2, wherein the chamfer at the radially outer end of the respective permanent magnet extends at a distance of 0.5 mm to 3.55 mm from the outer circumference of the rotor base body parallel to the tangential direction.

15. The rotor according to claim 6, wherein the radial inner ends of the permanent magnets arranged in the recesses of the permanent magnet group have a distance between them of a maximum of 3 mm.

16. The rotor according to claim 8, wherein the first angle is between 85° and 130°.

17. The rotor according to claim 9, wherein the second angle is between 100° and 175°.

18. The rotor according to claim 10, wherein the outer diameter of the rotor base body is between 120 mm and 170 mm, and wherein the inner diameter of the rotor base body is between 40 mm and 80 mm.
